(19) United States
(12) Patent Application Publication
(10) Pub. No.: US 2005/0069213 A1
(43) Pub. Date: Mar. 31, 2005

(54) Image processing apparatus

(76) Inventor: Yoshifumi Aoki, Tokyo (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 10/947,936

(22) Filed: Sep. 23, 2004

(30) Foreign Application Priority Data
Sep. 26, 2003 (JP) JP2003-335987

(51) Int. Cl. G06K 9/36

(52) U.S. Cl. 382/251

(57) ABSTRACT

An image processing apparatus of this invention for quantizing the orthogonal transformation coefficient value of image information supplied from a first path and for dequantizing the quantized orthogonal transformation coefficient value supplied from a second path stores the multiplication result of a quantization table and a quantization scale value as a quantization step size table and stores the reciprocal number of the multiplication result as a dequantization step size table. Then the quantization step size table or the dequantization step size table is selected according to an input. The selected result is multiplied by a corresponding orthogonal transformation coefficient value or a quantized orthogonal transformation coefficient value. This invention is capable of omitting time to calculate a quantization step size table and a dequantization step size table according to the characteristics of image information, resulting in improving quantization and dequantization efficiency per unit time.

### BACKGROUND OF THE INVENTION

1. Field of the Invention

This invention relates to an image processing apparatus and, more particularly, is suitably applied to a case of compressing and decompressing still images.

2. Description of the Related Art

A Joint Photographic Experts Group (JPEG) is a very known technique to compress and decompress still images. To compress a still image, this technique converts the still image data into an orthogonal transformation coefficient value which is data of frequency domain, with prescribed orthogonal transformation, multiplies (quantizes) this orthogonal transformation coefficient value by a prescribed quantization step value, and performs a prescribed encoding process on this multiplication result, thereby creating compressed image data.

To decompress a still image, on the other hand, this technique performs a prescribed decoding process on the compressed image data, restores an orthogonal transformation coefficient value by multiplying (dequantizing) the decoding result by a reciprocal number of the quantization step value, which was used for the quantization, and performs prescribed orthogonal inverse transformation on the orthogonal transformation coefficient value, thereby restoring the still image data.

For this purpose, an image processing apparatus provided with a single circuit for the quantization and the dequantization has been proposed (for example, refer to Japanese Patent Laid-Open No. 6-189285).

To compress a still image, this image processing apparatus enters into a multiplexer a result (orthogonal transformation coefficient value) of orthogonal transformation externally supplied and a quantization step value according to the characteristics of the still image data, and outputs the multiplication result to a latter stage. To decompress a still image, on the other hand, this image processing apparatus searches a table for a reciprocal number of a result (quantized transformation coefficient) of a decoding process externally supplied, enters this reciprocal number and the result of the decoding process into the multiplexer, and outputs the multiplication result to a circuit of a latter stage, the table being stored in an internal memory and comprising the reciprocal numbers of quantization step values.

By the way, since a quantization step value is calculated according to the characteristics of still image data outside the circuit, this image processing apparatus cannot start quantization of a corresponding orthogonal transformation coefficient value until the calculation result is obtained. This decreases quantization and dequantization efficiency per unit time, resulting in decreasing processing efficiency of the entire apparatus to compress and decompress still images.

### SUMMARY OF THE INVENTION

In view of the foregoing, an object of this invention is to provide an image processing apparatus capable of improving processing efficiency to compress and decompress images.

The foregoing objects and other objects of the invention have been achieved by the provision of an image processing apparatus for quantizing an orthogonal transformation coefficient value of image information supplied from a first path and for dequantizing a quantized orthogonal transformation coefficient value supplied from a second path. This image processing apparatus comprises: a storage means for storing a multiplication result of a quantization table and a quantization scale value as a quantization step size table and storing the reciprocal number of the multiplication result as a dequantization step size table; a selection means for receiving the orthogonal transformation coefficient value or the dequantized orthogonal transformation coefficient value and selecting the quantization step size table or the dequantization step size table according to the received value; and a multiplication means for multiplying the quantization step size table or the dequantization step size table selected by the selection means, by the corresponding orthogonal transformation coefficient value or quantized orthogonal transformation coefficient value.

Therefore, this invention can omit time to calculate a quantization step size table or a dequantization step size table according to the characteristics of image information. This can reduce time to calculate a corresponding orthogonal transformation coefficient value or quantized orthogonal transformation coefficient value with the step size table, resulting in improving quantization and dequantization efficiency per unit time.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a block diagram showing an entire construction of an image processing system according to this embodiment;

FIG. 2 is a block diagram showing a construction of a JPEG processing unit;

FIG. 3 is a block diagram showing a construction of a quantization circuit;

FIG. 4 is a schematic diagram explaining an example of data level limits;

FIG. 5 is a schematic diagram showing an example of a dequantization step size table;

FIG. 6 is a schematic block diagram showing a construction of a quantization circuit according to another embodiment; and

FIG. 7 is a schematic diagram explaining creation of a quantization step size for a DC coefficient of an intra-block.

### DETAILED DESCRIPTION OF THE EMBODIMENT

Preferred embodiments of this invention will be described with reference to the accompanying drawings:

### (1) Construction of Image Processing System

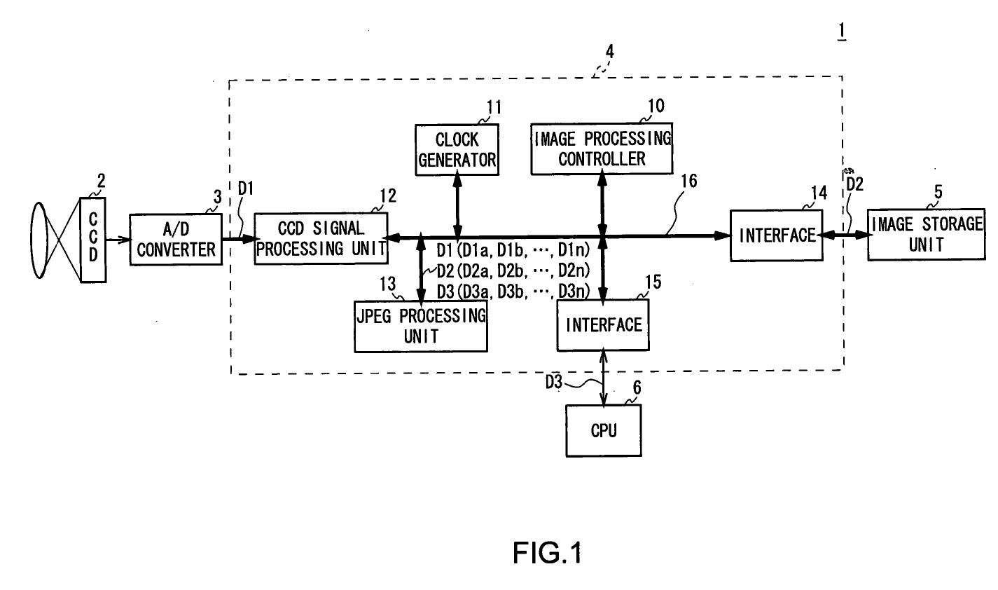

FIG. 1 shows an image processing system 1 according to this invention. This image processing system 1 creates data (hereinafter, referred to as still image data) D1 with an Analog/Digital (A/D) converter 3 from an image signal of a subject obtained by a Charge Coupled Device (CCD) 2, and gives this data D1 to an image processing block 4.

This image processing block 4 compresses the still image data D1 with the JPEG technique, and stores the obtained data (hereinafter, referred to as compressed image data) D2 in an image storage unit 5, the data D2 having a smaller amount than the still image data D1.

When a Central Processing Unit (CPU) 6 controlling the entire operation of the image processing apparatus 1 issues a data readout command, the image processing block 4 reads compressed image data D2 from the image storage unit 5, decompresses the compressed image data D2 with the JPEG technique, and gives the restored original still image data D1 to the CPU 6. The CPU 6 sends the still image data D1 to a display unit (not shown) being connected thereto or to another apparatus via a communication processing unit (not shown) being connected thereto.

As shown in FIG. 1, this image processing block 4 is composed of an image processing controller 10, a clock generator 11, a CCD signal processing unit 12, a JPEG processing unit 13, interfaces 14 and 15, which are connected with a bus 16, the image processing controller 10 controlling the entire operation of the image processing block 4.

This image processing block 4 performs the above image compression and image decompression under the control of the image processing controller 10 controlling each unit 12 to 15 according to a clock generated by the clock generator 11.

To compress an image, the CCD signal processing unit 12 performs various kinds of preprocesses such as white balance adjustment and gray-scale correction, transformation to luminance components and color components, on the still image data D1 given from the A/D converter 3, and sequentially sends the obtained luminance component data and color component data to the JPEG processing unit 13 as data of a prescribed size (hereinafter, referred to as unit image component data) D1a, D1b, . . . , D1n.

Then, the JPEG processing unit 13 compresses the unit image component data D1a, D1b, . . . , D1n to create compressed data of a prescribed size (hereinafter, referred to as compressed unit data) D2a, D2b, . . . , D2n. These compressed unit data D2a, D2b, . . . , D2n are stored in the image storage unit 5 via the interface 14 as compressed image data D2 under the control of the image processing controller 10.

To decompress the image, on the other hand, the JPEG processing unit 13 decompresses the compressed unit data D2a, D2b, . . . , D2n sequentially obtained from the image storage unit 5, sends the restored unit image component data D3a, D3b, . . . , D3n to the CPU 6 via the interface 15 as still image data D3 corresponding to the original still image data D1, so that the CPU 6 outputs the still image data D3 to the display unit or another apparatus.

As described above, this image processing system 1 is capable of storing a still image of a subject, and displaying the still image, which has been stored, or giving it to another apparatus.

### (2) Construction of JPEG Processing Unit

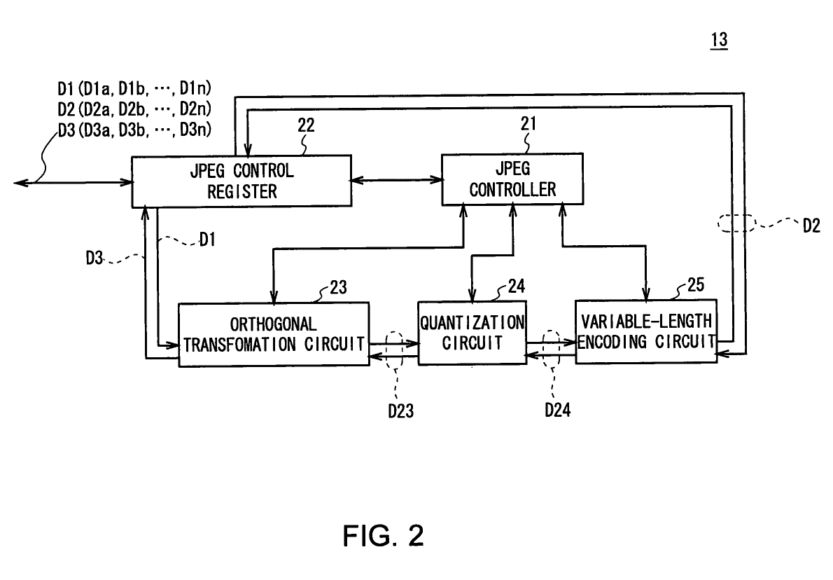

FIG. 2 shows the construction of the JPEG processing unit 13. This JPEG processing unit 13 is composed of a JPEG controller 21 for controlling the entire operation of the JPEG processing unit 13, a JPEG control register 22, an orthogonal transformation circuit 23, a quantization circuit 24 and a variable-length encoding circuit 25. This JPEG control register 22 stores various parameters as data in an internal memory (not shown).

This JPEG processing unit 13 executes the image compression or the image decompression with various kinds of data given from the JPEG control register 22 under the control of the JPEG controller 21 controlling the orthogonal transformation circuit 23, the quantization circuit 24, and the variable-length encoding circuit 25.

That is, when the JPEG control register 22 receives first unit image component data D1a from the CCD signal processing unit 12 (FIG. 1), the JPEG controller 21 sends this unit image component data D1a to the orthogonal transformation circuit 23 and starts the image compression process.

The orthogonal transformation circuit 23 divides the unit image component data D1a into pixel blocks each comprising eight pixels X eight pixels, performs Discrete Cosine Transform (DCT) process on the each pixel block, and sends the obtained DCT coefficient value for each pixel block to the quantization circuit 24 as data (hereinafter, referred to as DCT coefficient data) D23.

The quantization circuit 24 performs the quantization process to multiply a quantization step value (hereinafter, referred to as quantization table) assigned to each pixel of the pixel block by a DCT coefficient value corresponding to the DCT coefficient data D23, to create a quantization coefficient value as data (hereinafter, referred to as quantization coefficient data) D24, and sends this to the variable-length encoding circuit 25.

The variable-length encoding circuit 25 creates compressed data D2a by performing an encoding process such as a Huffman encoding, on the quantization coefficient data D24, and stores it in a memory (not shown) of the JPEG control register 22.

The unit image component data D1b to D1n sequentially given from the CCD signal processing unit 12 (FIG. 1) are processed in the same manner, and stored as compressed data D2b to D2n in the memory (not shown) of the JPEG control register 22. Then, the compressed data D2a to D2n being stored in the JPEG control register 22 are read by the image processing controller 10 as compressed image data D2 and stored in the image storage unit 5 (FIG. 1) via the interface 14.

When first compressed data D2a out of the compressed image data D2 is output from the image storage unit 5 (FIG. 1), on the other hand, the JPEG controller 21 sends this compressed data D2a to the variable-length encoding circuit 25 to start the image decompression process.

The variable-length encoding circuit 25 restores the original quantization coefficient data D24 by decoding the compressed data D2a, and sends this to the quantization circuit 24.

The quantization circuit 24 performs the dequantization process to multiply the reciprocal number of each quantization step value of the quantization table used for the quantization process, by each quantization coefficient value corresponding to the quantization coefficient data D24, to restore the DCT coefficient data D23 comprising the original DCT coefficient value, and sends this data D23 to the orthogonal transformation circuit 23.

The orthogonal transformation circuit 23 applies the inverse DCT process to the DCT coefficient data D23 to restore the unit image component data D3a and stores this in the memory (not shown) of the JPEG control register 22.

The compressed data D2b to D2n sequentially supplied from the image storage unit 5 (FIG. 1) are processed in the same manner and stored in the memory (not shown) of the JPEG control register 22 as unit image component data D3b to D3n. Then the unit image component data D3a to D3n being stored in the JPEG control register 22 are read by the image processing controller 10 as still image data D3 and sent to the CPU 6 (FIG. 1) via the interface 15 (FIG. 1).

As described above, the JPEG processing unit 13 is capable of compressing a still image and decompressing the compressed still image.

### (3) Construction of Quantization Circuit

The quantization circuit 24 of the JPEG processing unit 13 performs the above quantization process and dequantization process by components (luminance components and color difference components).

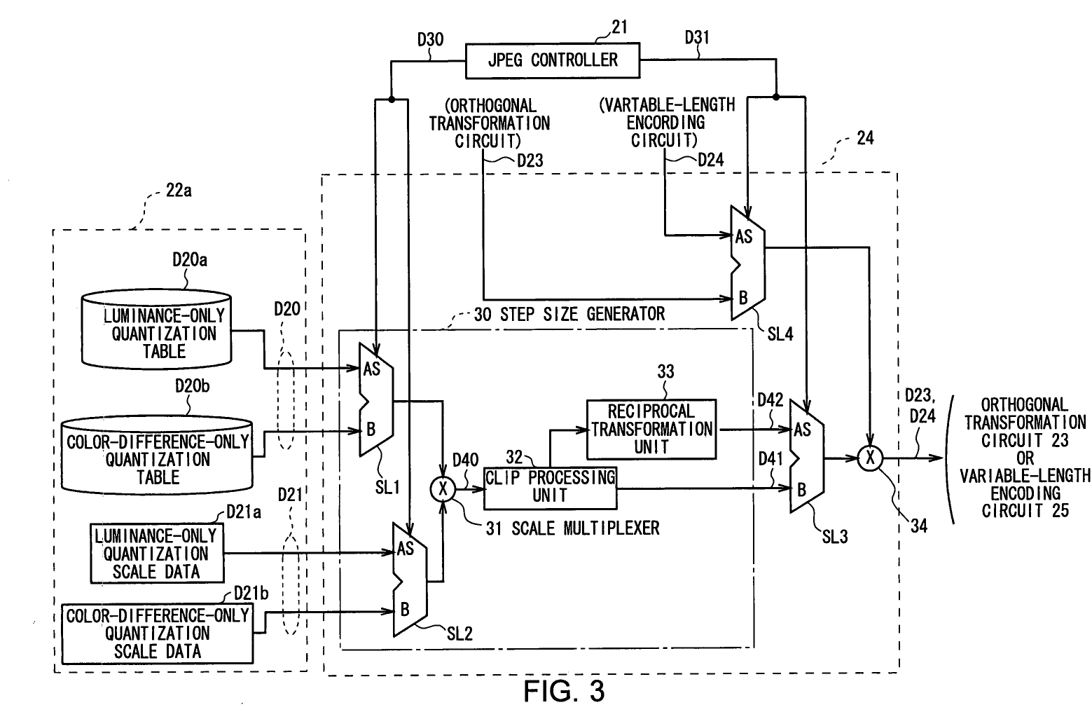

As shown in FIG. 3, the memory (hereinafter, referred to as a register memory) 22a of the JPEG control register 22 stores quantization tables, which are used for the quantization process and are different by components, as quantization tables D20 (luminance-only quantization table D20a and color-difference-only quantization table D20b).

In addition, the register memory 22a stores quantization scale values different by components (luminance components and color difference components), which are set by a user with an operating unit (not shown) being connected to the CPU 6 (FIG. 1), as data D21 (data of quantization scale values for luminance components is referred to as luminance-only quantization scale D21a and data of quantization scale values for color difference components is referred to as color-difference-only quantization scale D21b).

When receiving unit image component data D1 (D1a, D1b, . . . , or D1n) from the orthogonal transformation circuit 23 as a compression path or compressed data D2 (D2a, D2b, . . . , or D2n) from the variable-length encoding circuit 25 as a decompression path, the JPEG controller 21 selects quantization tables D20a and D20b and quantization scales D21a and D21b corresponding to the received data D1, D2, and sends the selected quantization tables D20 and quantization scales D21 to a step size generator 30 of the quantization circuit 24.

In actual, the JPEG controller 21 switches a first selector SL1 and a second selector SL2 provided in the step size generator 30 of the quantization circuit 24, with prescribed switching control data D30, in order to select a quantization table D20 and a quantization scale D21 corresponding to the components of the unit image component data D1, the first selector SL1 selecting the luminance-only quantization table D20a or color-difference-only quantization table D20b, the second selector SL2 selecting the luminance-only quantization scale D21a or the color-difference-only quantization scale D21b. Then the JPEG controller 21 sends them to a scale multiplexer 31 of the step size generator 30.

The scale multiplexer 31 multiplies each quantization step value of the quantization table D20 by the quantization value of the quantization scale D21, and sends the obtained quantization table (hereinafter, referred to as quantization step size table) D40 to a clip processing unit 32 of the latter stage.

The clip processing unit 32 limits the data amount of the quantization step size table D40 to a prescribed threshold value or lower, and sends the obtained quantization step size table D41 to a third selector SL3 and a reciprocal transformation unit 33.

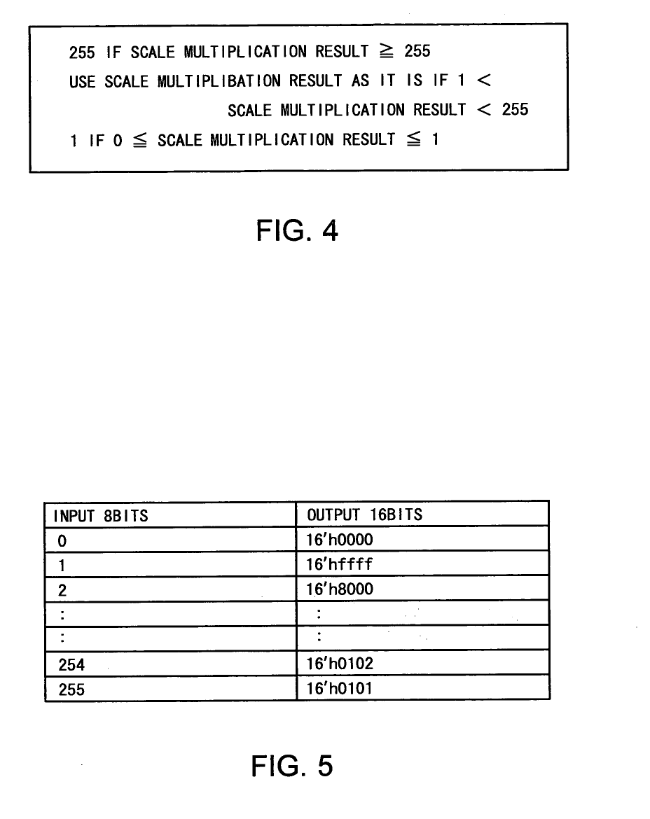

Specifically, as shown in FIG. 4, the clip processing unit 32 sets an integer value 255, which is a prescribed threshold value, as the quantization step size table D41 by discarding part of the quantization step size table D40 according to necessity in a case where the quantization step size table D40 is the integer value 255 or greater, sets the quantization step size table D40 as the quantization step size table D41 as it is in a case where the quantization step size table D40 is greater than an integer value 1 and less than the integer value 255, and sets an integer value 1 as the quantization step size table D41 by rounding up the quantization step size table D40 according to necessity in a case where the quantization step size table D40 is the integer value 1 or less.

The reciprocal transformation unit 33 stores in an internal memory the reciprocal numbers of the quantization step sizes of the quantization step size tables D41 as tables (hereinafter, referred to as dequantization step size tables), differently by components (luminance components and color difference components). The dequantization step size tables are stored in the internal memory of the reciprocal transformation unit 33 as values shown in FIG. 5, for example.

Then the reciprocal transformation unit 33 refers to the dequantization step size tables to convert the quantization step size of the quantization step size table D41 given from the clip processing unit 32 into a corresponding dequantization step size table D42, and sends this table D42 to the third selector SL3.

As described above, the step size generator 30 sends the quantization step size table D41 or the dequantization step size table D42 corresponding to the components of the unit image component data D1 (D1a, D1b, . . . , or D1n) or the compressed data D2 (D2a, D2b, . . . , or D2n), and the dequantization step size table D42 to the third selector SL3.

The quantization circuit 24 performs the quantization process to multiply the quantization step size table D41 by the orthogonal transformation result (DCT coefficient data D23) given from the orthogonal transformation circuit 23, or performs the dequantization process to multiply the dequantization step size table D42 by the decoding result (quantization coefficient data D24) given from the variable-length encoding unit 25 (FIG. 2).

In a case of the quantization process, the quantization circuit 24 switches the third selector SL3 and a fourth selector SL4 with prescribed switching control data D31 under the control of the JPEG controller 21, the third selector SL3 selecting the quantization step size table D41 or the dequantization step size table D42, the fourth selector SL4 selecting the DCT coefficient data D23 or the quantization coefficient data D24.

In this case, in the quantization circuit 24, the multiplexer 34 creates quantization coefficient data D24 comprising a quantization coefficient value by multiplying the quantization step size of the quantization step size table D41 by a corresponding DCT coefficient value of the DCT coefficient data D23, and sends this to the variable-length encoding unit 25. The variable-length encoding unit 25 encodes the quantization coefficient data D24, and sends the resultant to the JPEG control register 22 as compressed data D2a, D2b, . . . , D2n.

In a case of the dequantization process, on the other hand, the quantization circuit 24 switches the third selector SL3 and the fourth selector SL4 with switching control data D31 under the control of the JPEG controller 21.

In this case, in the quantization circuit 24, the multiplexer 34 creates the DCT coefficient data D23 comprising a DCT coefficient value by multiplying the dequantization step size of the dequantization step size table D42 by a corresponding quantization coefficient of the quantization coefficient data D24, and sends this to the orthogonal transformation circuit 23. The orthogonal transformation circuit 23 performs an inverse DCT process on the DCT coefficient data D23, and sends the resultant to the JPEG control register 22 as the unit image component data D3a, D3b, . . . , D3n.

As described above, the quantization circuit 24 of the JPEG processing unit 13 is capable of performing both the quantization process and the dequantization process by components (luminance components and color difference components).

### (4) Operation and Effects of this Embodiment

According to the above configuration, the JPEG processing unit 13 multiplies a quantization table D20 by a quantization scale D21, and converts the resultant quantization step size table D41 into a corresponding dequantization step size table D42 based on the dequantization step size table previously stored in the reciprocal transformation unit 33, the quantization table D20 and the quantization scale previously stored in the register memory 22a.

Then the JPEG processing unit 13 enters the DCT transformation data D23 supplied from the compression path or the quantization coefficient data D24 supplied from the decompression path, into the quantization circuit 24, selects the quantization step size table D41 or the dequantization step size table D42 according to the entered data, and multiplies the selected step size table D41, D42 by the corresponding DCT coefficient data D23 or quantization coefficient data D24.

Therefore the JPEG processing unit 13 can omit time to calculate the quantization step size table D41 and the dequantization step size table D42 according to the characteristics of image information (unit image component data D1). This can reduce time which is taken until the step size table D41, D42 is multiplied by the corresponding DCT coefficient data D23 or quantization coefficient data D24, thus making it possible to improve quantization and dequantization efficiency per unit time.

In addition, in this case, the JPEG processing unit 13 stores the quantization scales D21 set by the user and also the reciprocal numbers of the multiplication results of the quantization scales D21 within the set limit and the quantization tables D20, as the dequantization step size table.

Therefore, the JPEG processing unit 13 is capable of performing the quantization process and the dequantization process by using a quantization step value (quantization step size table D41, dequantization step size table D42) reflected by a variable quantization scale D21, not by a fixed value, thus making it possible to obtain image information with desired image quality without deteriorating the quantization and dequantization efficiency per unit time.

Further, in this case, the JPEG processing unit 13 stores the quantization tables D20, the quantization scales D21 set by the user, and the dequantization step size tables, differently by luminance components and color difference components.

Since a rough quantization process can be performed for only luminance components, this JPEG processing unit 13 can improve the quantization and dequantization efficiency per unit time with reducing processes for quantization and dequantization (multiplication), as compared with a case of performing the quantization process having the same rough level for the luminance components and the color difference components. In this case, although the rough quantization process is performed for the luminance components, there is no problems in reproduction of images based on image information because human beings have sensitivity for luminance components more than for color difference components.

According to the above configuration, the quantization step size table D41 and the dequantization step size table D42 are created based on the previously stored quantization tables D20, quantization scales D21, and dequantization step size tables, and the step size table D41, D42 selected according to the entered DCT coefficient data D23 or quantization coefficient data D24 is multiplied by the corresponding processing target D23, D24. This can improve quantization and dequantization efficiency per unit time, thus making it possible to improve processing efficiency to compress and decompress images.

### (5) Other Embodiments

In the above embodiment, the quantization tables D20 and the quantization scales D21 are stored in the register memory 22a (FIG. 3), and the dequantization step size tables are stored in the reciprocal transformation unit 33 (FIG. 3). This invention, however, is not limited to this and the quantization tables D20, the quantization scales D21 and the dequantization step size tables can be all stored in the register memory 22a.

Further, in the above embodiment, the quantization tables D20 and the quantization scales D21 are stored in the register memory 22a. This invention, however, is not limited to this and the quantization step size tables D41 created by multiplying the quantization tables D20 by the quantization scales D21 can be stored in this memory 22a. In this case, the scale multiplexer 31 can be omitted, resulting in realizing a small-sized apparatus. In addition, the multiplication process by the scale multiplexer 31 can be omitted as well, resulting in improving quantization and dequantization efficiency per unit time.

Still further, in the above embodiment, one quantization table D20 is stored in the register memory 22a by image components (luminance components and color difference components). This invention, however, is not limited to this and a plurality of quantization tables can be stored in the register memory 22a by the image components. In this case, as a technique to select one quantization table out of the plurality of quantization tables, the JPEG controller 21 can be designed to calculate the level of the high-frequency components included in the DCT coefficient data D23 or the quantization coefficient data D24 as an activity, and select a quantization table suitable for the activity. By doing this, the quantization and dequantization more suitable for the characteristics of image information can be performed.

Still further, in the above embodiment, the JPEG controller 21 and the third selector SL3 for switching inputs with switching data D31 given from the JPEG controller 21 are applied as a selection means for receiving an orthogonal transformation coefficient value or a quantized orthogonal transformation coefficient value and selecting a quantization step size table or a dequantization step size table according to the received value. This invention, however, is not limited to this and other configuration can be applied.

Still further, in the above embodiment, the quantization scale D21 is set with the operating unit. This invention, however, is not limited to this and the scale can be set automatically, without the operation unit. In this case, the JPEG controller 21 (FIG. 3) performs this setting, for example. Specifically, the JPEG controller 21 compares an code amount of the compressed data D2 (D2a, D2b, . . . , or D2n) with a previously set threshold value. Then the JPEG controller 21 sets a scale value so that this scale value becomes larger as the comparison result is large and the scale value becomes smaller as the comparison result is small. And the JPEG controller 21 performs the quantization process and the dequantization process with the set scale value, in the above-described manner. By automatically (adaptively) setting a scale value according to the comparison result, even users who do not know about images can compress and decompress images with keeping image quality.

Still further, in the above embodiment, the image compression process and the image decompression process under the JPEG technique are performed on the still image data D1. This invention, however, is not limited to this and the image compression process and the image decompression process under the Moving Picture Experts Group (MPEG) technique can be performed on moving picture data.

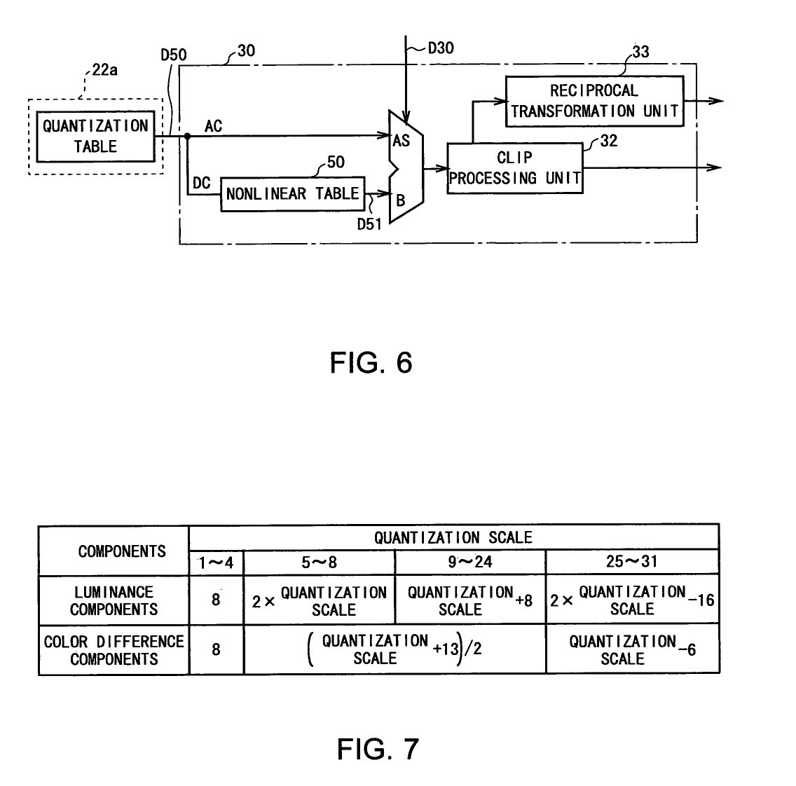

In this case, as shown in FIG. 6 in which the same reference numerals are applied to parts corresponding to those of FIG. 3, a register memory 22a stores a quantization step value assign to each pixel of a pixel block corresponding to MPEG, as a quantization table D50 by components, instead of the quantization table D20. Then a step size generator 30 selects the quantization table D50 via a selector SL1 in a case of AC components of an intra-block and sends this to a clip processing unit 32 of the latter stage. In a case of DC components of the intra-block, on the other hand, the step size generator 30 selects the quantization step size table D51 via the selector SL1 and sends this to the clip processing unit 32 of the latter stage, the quantization step size table D51 obtained by converting the quantization table D50 under the matters shown in FIG. 7 with a nonlinear table transformation unit 60. The step size generator 30 stores the reciprocal numbers of the quantization step values of the quantization table D50 and the quantization step size table D51 as the dequantization step size tables by components in a dequantization transformation unit 33. By doing so, the compression and decompression of moving pictures can be performed, similarly to the above embodiment.

Still further, in the above embodiment, the image processing apparatus for quantizing the orthogonal transformation coefficient value of image information supplied form a first path and for dequantizing the quantized orthogonal transformation coefficient value supplied form a second path is composed of the JPEG controller 21, the JPEG control register 22 and the quantization circuit 24 of the JPEG processing unit 13. This invention, however, is not limited to this and can be applied to other image processing apparatuses composed by setting the processing contents of the JPEG controller 21, the JPEG control register 22 and the quantization circuit 24 as modules.

This invention is usable for compression and decompression of images.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

1. An image processing apparatus for quantizing an orthogonal transformation coefficient value of image information given from a first path and for dequantizing a quantized orthogonal transformation coefficient value given from a second path, comprising:
storage means for storing a result of multiplication of a quantization table and a quantization scale value as a quantization step size table and for storing a reciprocal number of the result of the multiplication as a dequantization step size table;
selection means for receiving the orthogonal transformation coefficient value or the quantized orthogonal transformation coefficient value and selecting the quantization step size table or the dequantization step size table according to the received value; and
multiplication means for multiplying the quantization step size table or the dequantization step size table selected by said selection means and a corresponding orthogonal transformation coefficient value or quantized orthogonal transformation value.

2. The image processing apparatus according to claim 1, wherein said storage means stores the quantization step size table and the dequantization step size table by luminance components and color difference components.

3. The image processing apparatus according to claim 1, wherein:
said storage means stores the quantization table and the quantization scale value set by a user, and stores a reciprocal number of a result of the multiplication of the quantization scale value within a set limit and the quantization table, as the dequantization step size table; and
the selection means comprises:
scale multiplication means for creating the quantization step size table by multiplying said quantization table by the quantization scale value; and
transformation means for transforming the quantization step size table created by said scale multiplication means into corresponding the dequantization step size table, based on said dequantization step size table being stored in said storage means.

4. The image processing apparatus according to claim 3, wherein
said storage means stores the quantization table, the quantization scale value and the dequantization step size table, differently by luminance components and color difference components.
